(19) United States
(12) Patent Application Publication
(10) Pub. No.: US 2005/0268218 A1
(43) Pub. Date: Dec. 1, 2005

(54) Method and system for checking downloaded input form

(76) Inventors: Mitsuhiko Yoshimura, Tokyo (JP); Masashi Tsuchida, Machida (JP); Hitoshi Ashida, Kawasaki (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/062,825

(22) Filed: Feb. 23, 2005

(30) Foreign Application Priority Data
Apr. 28, 2004 (JP) 2004-132538

(51) Int. Cl. G06F 17/21

(52) U.S. Cl. 715/505; 715/780

(57) ABSTRACT

A form transmitting unit 112 of an application server 110 creates as-saved form information containing form information by required form type and check information for verifying input data and downloads it to a client personal computer 130 of a requesting client. A form uploading unit 133 uploads form data containing the as-saved form information received and input data inputted off line to be added thereto, to the application server 110. A form receiving unit 115 checks the received form information as required and the input data using the check information.

### CLAIM OF PRIORITY

The present application claims priority from Japanese application serial No. 2004-132538, filed on Apr. 28, 2004, the content of which is hereby incorporated by reference into this application.

### BACKGROUND OF THE INVENTION

1. Filed of the Invention

The present invention relates to technologies for downloading form information to a requesting client via a network and uploading form information containing data inputted offline to a site for checking the form.

2. Description of the Related Art

As technologies for embedding check information other than a form in an electronic form for use in verification and access limitation, Japanese Patent Laid-open No. 2003-141438 discloses technologies for storing an individual's user information in an electronic form for use in the verification of the electronic form distributed to a server. In addition, the U.S. Pat. No. 6,185,684 discloses technologies for embedding permission information in a document for use in limiting access to the document.

### SUMMARY OF THE INVENTION

Form input systems are available in two types. One type of form input system displays a form window for use in data input to a server in environments where the system is connected to the Internet. The other type of form input system downloads a form window to a client computer (personal computer) for use in offline data input and uploads the result of the downloaded form to a server as required. If the result of the form is uploaded without adjustments, offline data input, unlike online data input, will suffer low-quality data input, such as mismatch with data in a master file and discordance with restrictions.

For this reason, it is required that detection should be made to see if there is disagreement between form data inputted offline and data stored in a server. Since data stored in the server is changed independent of forms utilized offline, such a disagreement will happen when data inputted offline is merely received by the server. In addition, the viewpoint of how to determine such a disagreement varies depending on each application side that receives form information. If, for example, a format of a form is changed, whether or not a former form can be received depends on a policy established for a relevant application side. In addition, how to deal with any inputted form item not present on a master file depends on the policy established for a relevant application. If it is necessary to strictly set the check by application, a complete agreement is required between form items and master file items. However, verification methods need be set in a flexible manner, such as permitting data input of data items other than those present in a master file and enabling the reception of a former form only during a period of transfer from a former form to a new form.

In the above related art, however, flexible methods as mentioned above have not been provided but check is made from a viewpoint of where to deliver form information. This makes it impossible to check form information to be uploaded in situations associated with application policies, as described above. Thus, application needed to perform individual processing such as temporarily accumulating uploaded forms in a server before verification and notifying a client of the result of this verification later. In such individual processing, changing a verification method on the application side requires the modification of the application itself. For example, assume that the system is required to make a change from the rule of “receiving and approving form information uploaded if the data contains the same items as the master file although in a different format” to the rule of “receiving and approving form information uploaded only when both the format and items that the data has are the same as the master file has”. In this case, you would not be able to deal with a change of the rule without a change to the program.

The above related art is known as a means for performing form check. However, the related art cannot solve the problems described above.

An application side according to the present invention involves downloading information containing form information and additional check information to a requesting client. The requesting client uploads the form information containing additional input data inputted off line to the application side. The application side checks the form information as required and the input data based on the check information.

### BRIEF DESCRIPTION OF THE DRAWINGS

FIG. 1 is a configuration diagram of a system according to a first embodiment;

FIG. 2 shows an example of a display window on a client computer;

FIG. 3 shows an example of a data configuration for an AP server 110;

FIG. 4 shows an example of a data configuration for data transmitted to a client computer;

FIG. 5 is a flow chart for a form transmitting unit 112;

FIG. 6 is a flow chart for a form information uploading unit 133;

FIG. 7 is a flow chart for a form receiving unit 115;

FIG. 8 shows a check form pattern; and

FIG. 9 is a configuration diagram for a second embodiment.

### DESCRIPTION OF THE PREFERRED EMBODIMENTS

Preferred embodiments of the present invention will be described below in detail with reference to the drawings. Note that the detailed description below does not limit the present invention.

### First Embodiment

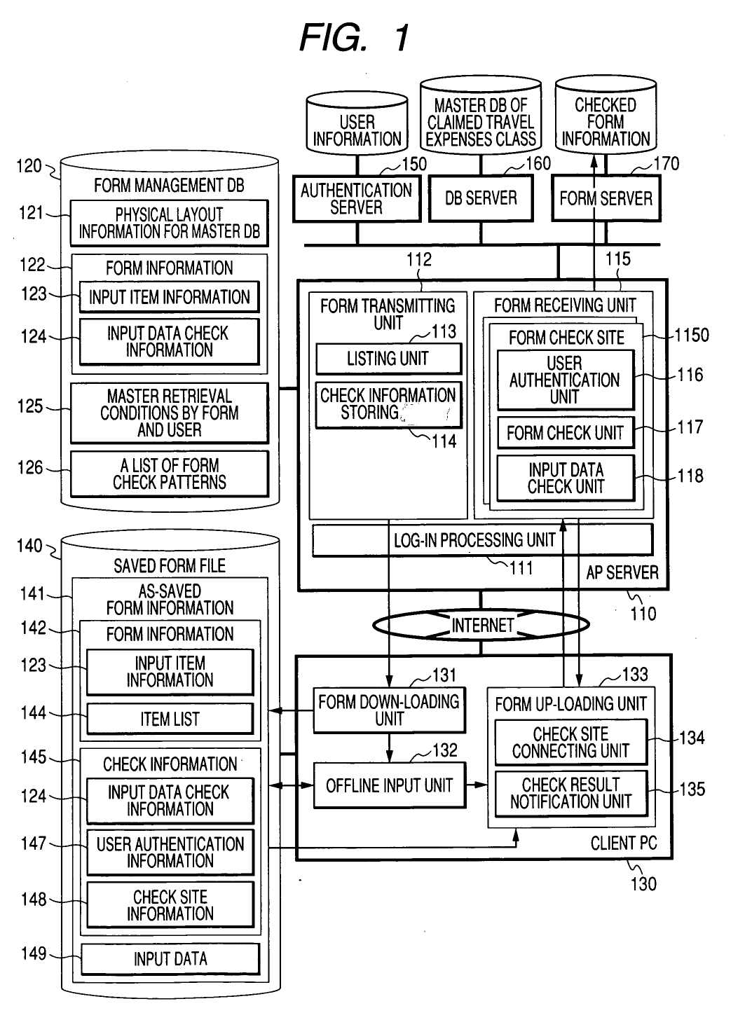

FIG. 1 is a configuration diagram for a client server system according to a first embodiment. The system includes an AP (application) server 110 of a web, a client personal computer 130, an authentication server 150, a DB (database) server 160, and a form server 170. Each of these devices has, not shown, a CPU, a memory, a display unit, an internal or external storage unit, an input unit such as a keyboard or a mouse, which are included in an ordinary computer.

The application server 110 of the web holds a form management database 120 in an internal or external storage unit. When a program is executed, the application server 110 holds a program for each of a form transmitting unit 112, a form receiving unit 115, and a log-in (or login) processing unit 111 on the memory. Each of these consecutive processing units is held as a program file in an internal or external storage unit and loaded into the memory when a server is started up or other occasions.

The client personal computer 130 holds a saved form file 140 in an internal or external storage unit. When the program is executed, the client personal computer 130 holds a program for each of a form down-loading (or downloading) unit 131, an offline input unit 132, and a form up-loading (or uploading) unit 133 on the memory, together with a web browser. Each of these consecutive processing units is held as a program file in an internal or external storage unit and loaded into thee memory when a server is started up.

The application server 110 of the web is connected via a LAN to the authentication server 150, the database server 160, and the form server 170. The application server 110 is connected via the Internet to the client personal computer 130.

The authentication server 150 has both a processor for performing user authentication and user information. User authentication is provided by the LDAP or the like, for example. The database server 160 manages a master database that the application server 110 refers to. In the example in FIG. 1, the database server 160 manages a master DB of claimed travel expenses class. The form server 170 saves and manages checked form information.

Note that the configuration shown in FIG. 1 is an example of the first embodiment and that the system configuration does not limit the present invention. The components of the system, the authentication server 150, the database server 160, the form server 170, and the application server 110 may be replaced with one or more servers, for example. In addition, network configurations other than shown in FIG. 1 may be used for the LAN and the Internet. For example, the entire network may be composed of a LAN or the Internet.

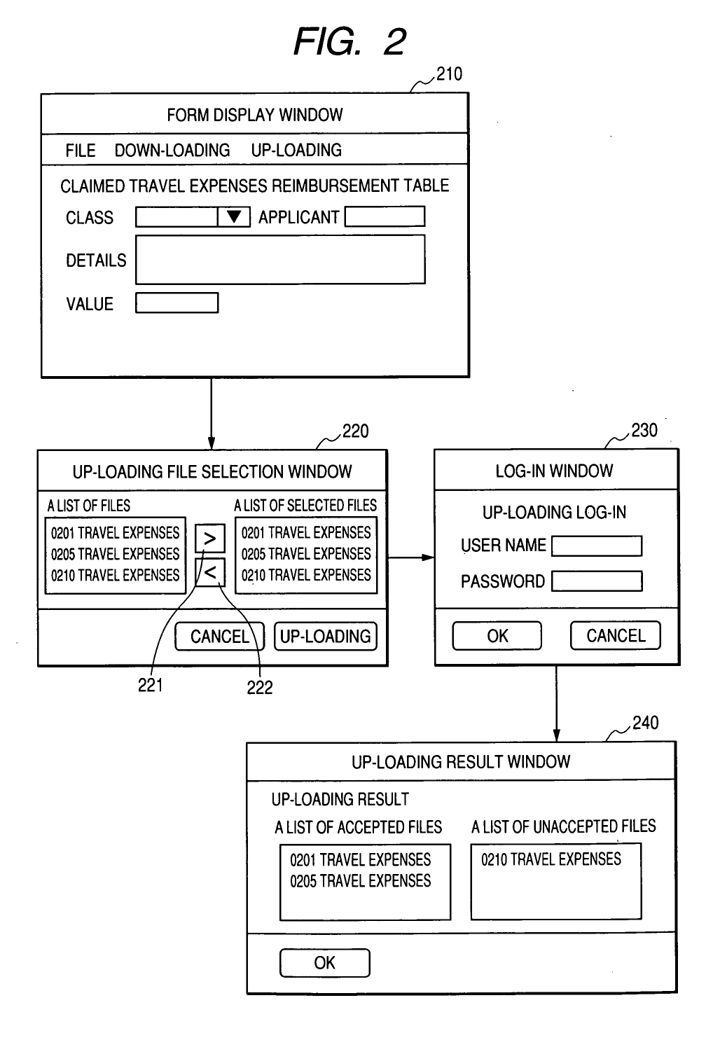

Windows displayed on the display unit of the client personal computer 130 will be described below with reference to FIG. 2. A web browser described below incorporates a plugin function for form display prepared in advance, which causes a form display window and related screens thereof to be displayed. The display of these windows follows user authentication by the login processing unit 111 and the authentication server 150. In addition, the login processing unit 111 creates a session for managing the connection of the client personal computer 130 on the Internet and a unique user name and password of each user of the client personal computer 130 are held on the application server 110.

A uniform resource locator (URL) is designated, which serves as a form downloading site on the Internet. After a series of operations such as login and form type selection, a form display window 210 shown in FIG. 2 appears. FIG. 2 shows an application form for travel expenses adjustment displayed. When displayed on the form display window 210, the application form for travel expenses adjustment allows a user to select a claimed travel expenses class from list items for data input. For trip expenses class, the user can select Domestic Same-Day (or One-Day) Trip, Domestic Night-Stay (or Overnight) Trip, or Travel Overseas from list items for input purposes. The form display window 210 has three common buttons independent of a form displayed: “File,” “Downloading,” and “Uploading.”

To down-load a designated form, the user selects “Downloading” from the menu. A file-saving window (not shown) is then displayed, which window is generally used to save files. When the “Save” button is pressed on the file-saving window, the designated form is saved in a file with a designated file name. When a button such as “Save” is pressed, the form downloading unit 131 of the client personal computer 130 is executed.

The form downloading unit 131 communicates with the form transmitting unit 112 on the application server 110. When transmitting form information on the server to the client personal computer 130, the form transmitting unit 112 adds check information prepared by a check information storing unit 114 to the form information. The form downloading unit 131 on the client personal computer 130 saves the data transmitted from the form transmitting unit 112 as as-saved form information 141 in the saved form file. The as-saved form information 141 contains form information present on the server and information added thereto, that is, check information 145 required for uploading check and an item list for form input such as list selection. After the above processing, the as-saved form information 141 is saved on the storage unit on the client personal computer 130. As described above, one feature of the present invention is to save form information to be downloaded by the server and check information added thereto in a client personal computer.

The user of the client personal computer 130 then inputs data to the as-saved form information 141 downloaded, thereby allowing the user to input data into the form in an offline environment where the application server 110 is not connected to the Internet. When inputting data into the form offline, the user selects the “File” button in the menu on the form display window 210. A file selection window (not shown) for the as-saved form information then appears. When the user designates a file name in the file selection window, the off line input unit 132 displays a form window for the saved form file 140 selected in the form display window 210. When, for example, a file for claimed travel expenses adjustment form is selected in an offline environment, a claimed travel expenses adjustment form appears in the form display window 210, as in an online environment. When the user inputs data in the form window, the offline input unit 132 receives any addition and/or change to input data 149 present in the as-saved form information 141. At the time, the off line input unit 132 may use input data check information 124 described later to perform possible checks such as checking the number of letters. Note that the off line input unit 132 can change only the input data 149 contained in the as-saved form information 141. The offline input unit 132 cannot change either form information 142 or check information 145. As described above, the user can save as-saved form information 141 changed off line as a saved form file 140 again.

The user of the client personal computer 130 then processes the as-saved form information. 141 inputted offline as described above for uploading to the application server 110. When uploading the above as-saved form information 141, the user selects the “Uploading” button in the menu in the form display window 210. An uploading file selection window 220 shown in FIG. 2 then appears. The uploading file selection window 220 has a file list display section and a selected-file list display section. The file list display section displays a list of files contained in the as-saved form information 141 saved in the client personal computer. The selected-file list display section displays file lists to be uploaded. To add a file to or delete a file from the selected-file list display section, the user uses a mouse or the like to select a desired file name from the file list display before pressing the button 221 or 222 for file shift. The uploading file selection window 220 allows the user to designate a plurality of files to be uploaded through the above operation. Note that the uploading file selection window 220 has two buttons: “Cancel” and “Uploading.” When the “Cancel” button is pressed, the uploading file selection window 220 disappears and the form display window 210 appears again. When the “Uploading” button is pressed, the form uploading unit 133 is executed.

The form uploading unit 133 first displays a login window 230. The login window is displayed not through a processing on the server but through processing on the client computer. The user of the client personal computer 130 inputs his/her user name and password in the login window 230. When the OK button is pressed on the login window 230, the form uploading unit 133 is executed. When the “Cancel” button is pressed, the uploading file selection window 220 appears again.

When the OK button is then pressed in the login window 230, the form uploading unit 133 transmits the inputted user name and password and the selected as-saved form information 141 to the form receiving unit 115. The form receiving unit 115 visits a form check site 1150 to check uploaded files. A plurality of form check sites 1150 are present. The form check site 1150 performs one of user authentication, form check, and input data verification and integrates the check results to determine whether to receive the uploaded file. When the uploading file is determined to be receivable, the as-saved form information 141 contained therein is saved as checked form information in the form server 170 via the application server 110. When the uploading file is determined to be unreceivable, the as-saved form information 141 contained therein is not saved. The form check site 1150 in the application server 110 then transmits the check results to the form uploading unit 133 on the client personal computer 130 for responding purposes. The form check site 1150 is a common program provided separately from applications for processing form information.

Upon receiving a response from the form check site 1150, the form uploading unit 133 on the client personal computer 130 displays an uploading result window 240. The uploading result window 240 distinguishes the names of upload files received from those of upload files not received for display purposes. This allows the user of the client personal computer 130 to know which of the upload files has been received successfully.

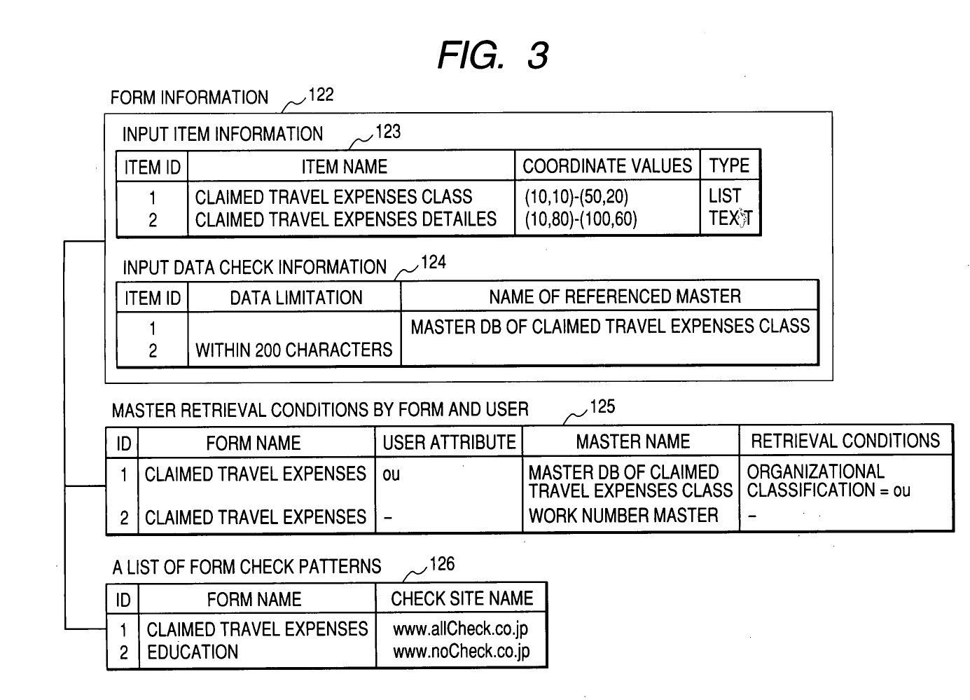

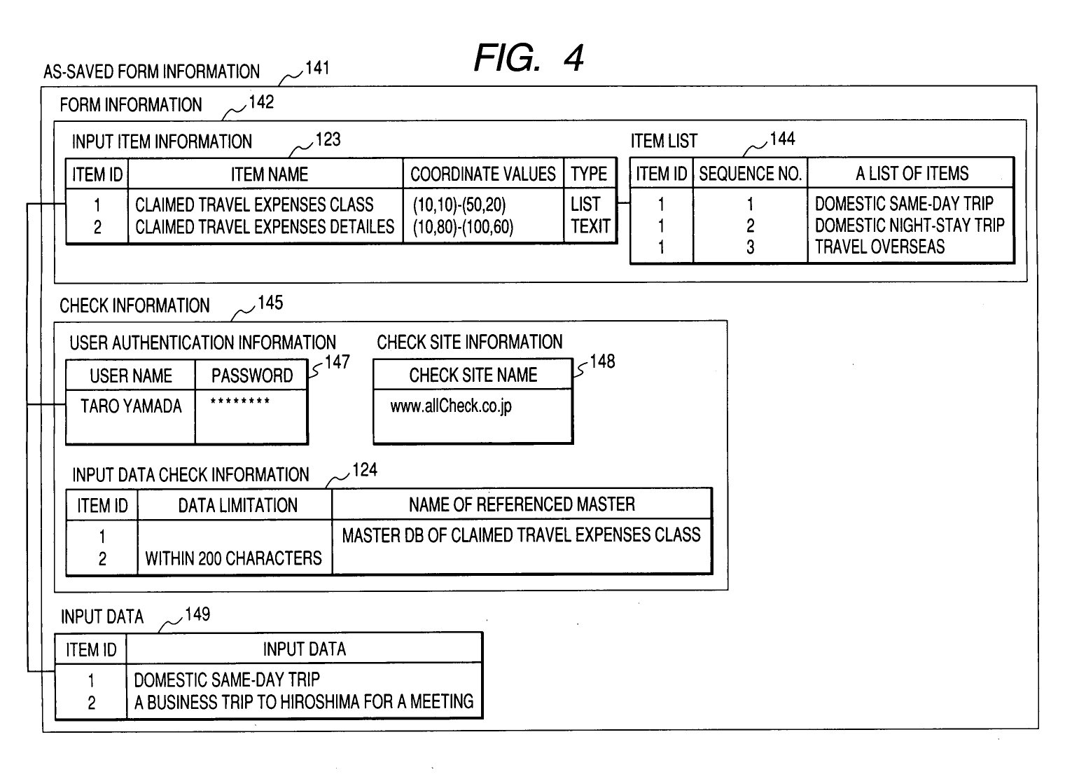

A data configuration for the form management database 120 and the saved form file 140 will be described below with reference with FIGS. 3 and 4. Note that physical layout information for master database 121 is information used to convert logical names into physical names of a master database. The physical layout information for master database 121 contains server names, table names, user names for connection to a database and the like.

FIG. 3 shows a data configuration for form information 122, master retrieval conditions by form and user 125, and a list of form check patterns 126.

Form information 122 consists of input item information 123 and input data check information 124. Input item information 123 contains form item names, coordinate values for showing item positions on a form, and item types (such as list input items and text input items). Based on the above components of input item information, a form input window appears on the screen. Input data check information 124 is used to verify input data for each item. The input data check information 124 retains a data limitation field to limit input data range and the number of letters and a reference master database name for reference in obtaining list item values. In an example shown in FIG. 3, a master DB of claimed travel expenses class is displayed under the referenced master database name for 1 under Item ID. Thus, verification is performed on item values for the master database of claimed travel expenses class. For 2 under Item ID, that is, claimed travel expenses details, it is shown under Data limitation that up to 200 letters may be inputted.

Master retrieval conditions by form and user 125 consist of a combination of a form name and a user attribute, and a combination of a master database name and a master database retrieval conditions. The user attribute field is filled with property values used for user information held in the authentication server 150. In this example, it is assumed that the LDAP is used as user information. It is shown that conditions for retrieving a master DB of claimed travel expenses class will be changed depending on what division ou, i.e., the organizational division refers to. If the login user of the client personal computer belongs to Division A, the check information storing unit 114 uses a retrieval condition “ou=“Division A”” and searches the master DB of claimed travel expenses class present in the database server 160. The result of the search is used as an item list shown in FIG. 4. In addition, the work number master database is a file that stores the next work number to be applied.

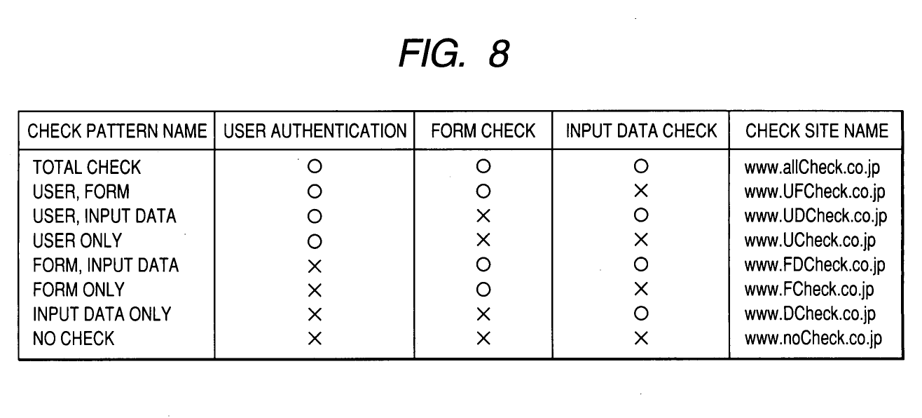

The list of form check patterns 126 associates form names with URLs that show the names of sites used for form check for setting purposes. In this embodiment, eight types of form check patterns are available as shown in FIG. 8. The URLs for check sites are given to these individual check patterns. Any one of these URLs is associated with a form name for storage in the list of form check patterns 126. Note that check patterns and check sites are independent of applications. Check patterns can be changed without changes to applications.

FIG. 4 shows a data format for as-saved form information 141. As-saved form information 141 consists of form information 142, check information 145, and input data 149.

Form information 142 consists of input item information 123 and an item list 144. Input item information 123 has been described in FIG. 3. The item list 144 contains input sets of item types listed. In this example, a set of item types listed is displayed under the item list for 1 under Item ID, that is, claimed travel expenses class. This set of item types listed has been produced by a listing unit 113.

Check information 145 consists of input data check information 124, user authentication information 147, and check site information 148. User authentication information 147 contains login user information authenticated by an application server 110 when the form downloading unit 131 is executed. Check site information 148 contains names of check sites that the check information storing unit 114 has retrieved for relevant form names based on form check patterns. For input data check information 124, the check information 145 contains the input data check information 124 of the form information 122.

Input data 149 contains data inputted via an offline input unit 132. In an example shown in FIG. 4, input data 149 contains input data concerning claimed travel expenses class and claimed travel expenses details. Note that when as-saved form information 141 is downloaded to a client personal computer 130, storage areas only are secured for input data 149 with no actual data stored.

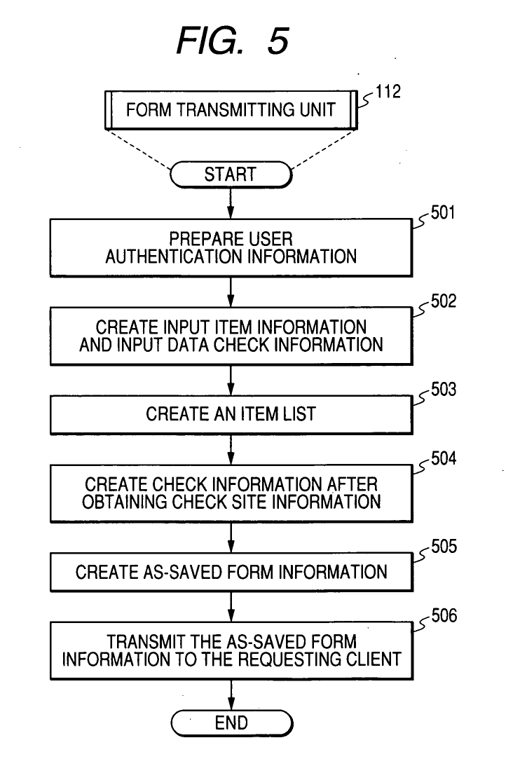

A processing flow for individual processors will be described below with reference with FIGS. 5, 6, and 7.

A processing procedure for a form transmitting unit 112 will be described below with reference with a flow chart shown in FIG. 5. The form transmitting unit 112 has a listing unit 113 and a check information storing unit 114, as shown in FIG. 1.

At Step 501, the form transmitting unit 112 obtains a user name and password from session information containing results of application server login. The form transmitting unit 112 then creates user authentication information 147 on the memory from the user name and password obtained. The unit 112 generates the above information 147 in a format unreadable by the client computer by utilizing known encryption technologies.

At Step 502, the form transmitting unit 112 downloads the form information 122 requested by the client personal computer 130 from a form management database 120 and loads the downloaded information into an application server 110. As a result, input item information 123 and input data check information 124 are created on the memory.

At Step 503, the listing unit 113 generates an item list 144. The unit 113 uses the user names obtained at Step 501 as check conditions and retrieves a master database contained in a database server 160 according to master retrieval conditions by form and user 125. The unit 113 then holds retrieval results thus obtained on the memory of the application server 110. Note that physical layout information for master database 121 is used when the logical name of the master database is converted into a physical name. The unit 113 obtains an item list for display under list item in a form as a result of the retrieval of the master database and utilizes the result to generate an item list 144. For example, the unit 113 retrieves a master DB of claimed travel expenses class and obtains an item list including “Domestic same-day (or one-day) trip,” “Domestic night-stay (or overnight) trip,” “Travel overseas” and the like.

At Step 504, the check information storing unit 114 generates check information 145, which include input data check information 124, user authentication information 147, and check site information 148. The user authentication information 147 and input data check information 124 have been generated at Step 501 and Step 502, respectively. At Step 504, the check information storing unit 114 generates and combines check site information 148 with the information already obtained on the memory. First, the unit 114 uses the name of a form to be downloaded as a retrieval condition and retrieves a list of form check patterns 126 before holding the result of the retrieval on the memory of the application server 110. The unit 114 then uses the result obtained and generates check site information 148. The unit 114 then combines the information 148 with the user authentication information 147 and input data check information 124 already obtained to generate check information 145.

At Step 505, the form transmitting unit 112 combines the three types of information obtained through a series of processing at the above steps, that is, the item list 144 and the check information 145 with input data 149 to generate as-saved form information 141, which will be sent to the client personal computer 130. At the time, the input data 149 contains no actual input data.

At Step 506, the form transmitting unit 112 transmits the as-saved form information 141 produced at Step 505 to the client personal computer 130 of the requesting client.

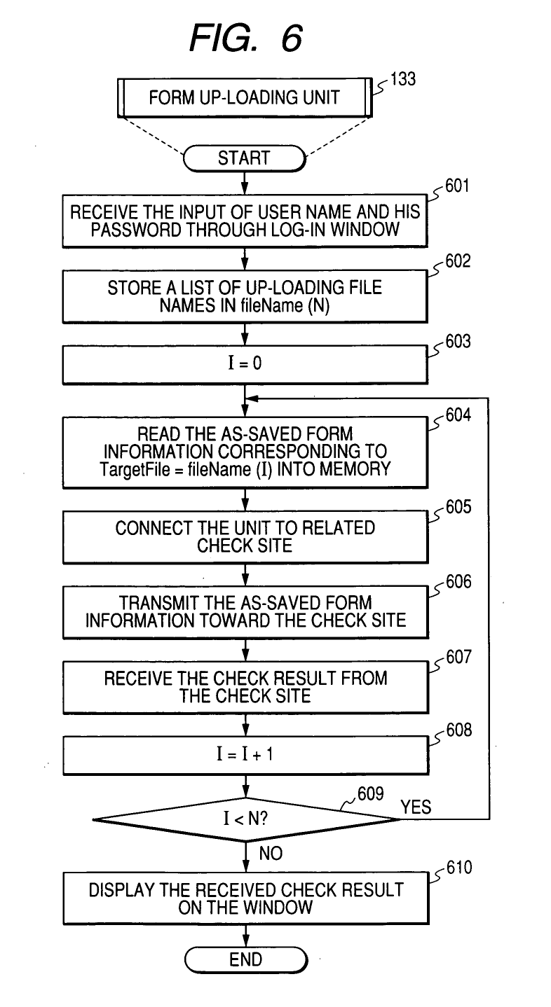

A processing procedure for a form uploading unit 133 will be described below with reference to a flow chart shown in FIG. 6. The form uploading unit 133 has a check site connecting unit 134 and a check result notification unit 135.

At Step 601, the form uploading unit 133 displays a login window 230. The user inputs his/her user name and password in the window.

At Step 602, the form uploading unit 133 loads a file list contained in a saved form file 140 into the memory for display purposes. The unit 133 then reads a file name list to be uploaded into fileName (N), an arrangement held in the processing unit, where N is the number of files to be uploaded. At Step 603, the file name arrangement number I is set to 0. At Step 604, a file name with a fileName (I) is stored into a variable TargetFile. The form uploading unit 133 then loads as-saved form information 141 corresponding to the variable TargetFile into the memory.

At Step 605, the check site connecting unit 134 obtains an URL for a check site for form-upload from the check site information 148 contained in the as-saved form information 141 and connects to the check site.

At Step 606, the form uploading unit 133 transmits the following form data to the above check site:
User name and password inputted at Step 601
File name for as-saved form information 141
Contents of as-saved form information 141

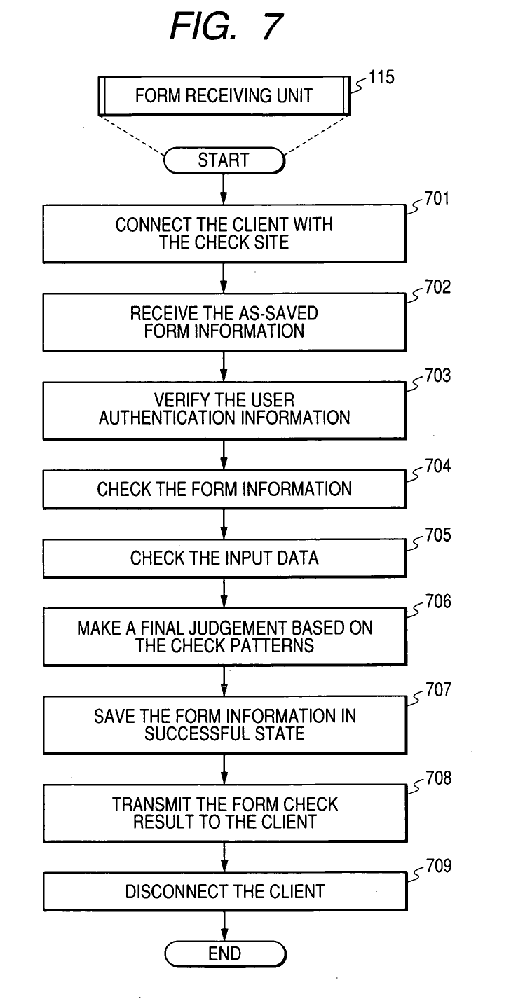

At Step 607, the form uploading unit 133 obtains the result of the check from the check site to hold the result on the memory of the client personal computer 130. Note that a form receiving unit 115 performs processing between Steps 606 and 607. The processing performed by the form receiving unit 115 will be described separately with reference with FIG. 7.

At Step 608, I=I+1 is used. At Step 609, the form uploading unit 133 determines if I<N. If I<N, the process returns to Step 604. Otherwise, Step 610 is performed.

At Step 610, the check site connecting unit 135 displays the received check result in an uploading result window 240.

A processing procedure for a form receiving unit 115 and a form check site 1150 will be described below with reference to a flow chart shown in FIG. 7. The form check site 1150 to which the form receiving unit 115 is connected has a user authentication unit 116, a form check unit 117, and an input data check unit 118.

At Step 701, the form receiving unit 115 connects a relevant check site to a client computer upon a request from a client personal computer 130.

At Step 702, the form check site 1150 receives the following form data from the client personal computer 130:
User name and password inputted at Step 601
File name for as-saved form information 141
Contents of as-saved form information 141

At Step 703, the user authentication unit 116 performs user authentication. The user authentication unit 116 first verifies if the same users and passwords that are the same as has been sent from the client personal computer 130 exist on user information managed by an authentication server 150. If the verification by the authentication server 150 is established, the unit 116 verifies if the user name and password transmitted from the client personal computer 130 coincide with the user authentication information 147 contained in the check information 145. If all user names and passwords coincide with the information 147, the user authentication unit 116 determines that user authentication has been established.

At Step 704, the form check unit 117 checks the form information 142. The form check unit 117 verifies the form information 142 by checking two input item information 123s. One is contained in the form information 122 held by an application server 110. Another is contained in as-saved form information 141 received from the client personal computer 130. If both input item information 123s coincides, the form check unit 117 determines that form check has been established.

At Step 705, the input data check unit 118 verifies input data 149. The unit 118 verifies input data 149 received from the client personal computer 130 by using input data check information 124. If the input data meets constraint conditions contained in the input data check information 124, the input data check unit 118 determines that the verification of the input data 149 has been established. If the input data check information 124 is derived from a master database, the input data check unit 118 verifies if the data item values in the input data 149 has been selected from an item list 144. It should be noted that the unit 118 uses the input data check information 124 held by the application server 110. This makes it possible to verify a mismatch between the server- and client-side information.

At Step 706, the form check site 1150 makes a final judgment based on the form and the input data check result as well as a judgment logic by check site shown in FIG. 8. As shown in FIG. 8, the use of the results of user authentication, form check, and input data check differs from one check site to another. For each check pattern shown in FIG. 8, o and x are used for each check pattern name to show if the judgment result for each of user authentication, form checks and input data check is used for the judgment result of each check site. In addition, check site names are shown. If total check under check pattern name is taken as an example, the following reception judgment is made: a permission for file uploading is given to only files for which all of user authentication, form check, and input data check have been established. For “no check” under check pattern name shown in FIG. 8, on the other hand, it is judged that any file is received.

At Step 707, the form receiving unit 115 saves form information successfully checked in the application server 110. In the example shown in FIG. 1, checked form information is saved in a form server 170. Note that forms themselves are saved in some cases and only input data taken out of forms are stored in other cases. In the example shown in FIG. 1, a form itself is saved but only input data may be saved in a database.

At Step 708, the form receiving unit 115 notifies the client personal computer 130 of form file names and check results. At Step 709, the form receiving unit 115 disconnects from the client personal computer 130 upon a request from the computer 130.

A supplementary description of the first embodiment will be made below. In the first embodiment, the client personal computer 130 transmits as-saved form information 141 including input item information 123 and input data check information 124 to the application server 110 when performing upload processing. However, the application server 110 may uniquely give an identification to each of the above types of information such that the client personal computer 130 transmits the identification to the server 110 instead of the above information.

In addition, the client personal computer 130 is, in flow charts already described, connected to and disconnected from the application server 110 for each form when transmitting form information to the server 110. Before the transmission of form information to the application server 110, forms to be uploaded may be sorted by check site and uploading processing may be performed based on sorting results such that the client personal computer 130 is less frequently connected to and disconnected from the check site. These can be carried out easily according to the embodiment already described.

### Second Embodiment

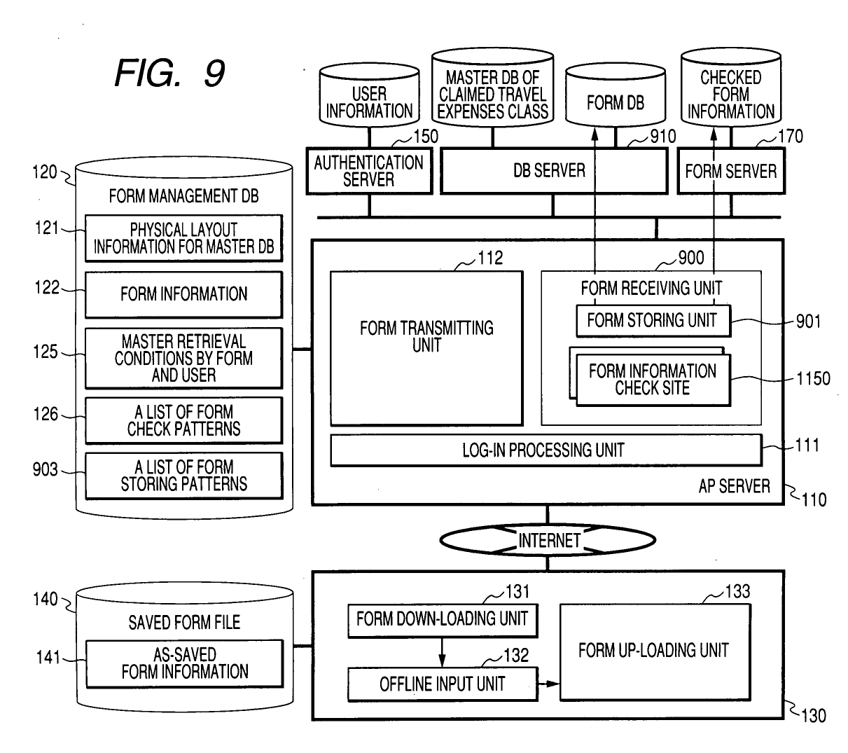

A second embodiment will be described below with reference to FIG. 9. Only the differences between the first and second embodiments will be described.

As shown in FIG. 9, the second embodiment has form database managed by a database server 910 where forms are stored and check form information managed by a form server 170. For a list of form storing patterns 903 holds setting information concerning which of the two types of information to store a form on form by form basis, together with a form name associated with the corresponding form.

The first embodiment stores checked form information directly in the form server 170 from a check site. For the second embodiment, the configuration the form receiving unit 900 is different from that of the form receiving unit in the first embodiment. Whereto store checked form information can be changed depending on setting information. The form receiving unit 900 has a form storing unit 901. The form storing unit 901 determines where to store form information based on the list of form storing patterns 903 already described above. In other words, the form storing unit 901 determines if the form information is stored in the form database or checked form information, shown in FIG. 9. Based on the result of the determination, the form storing unit 901 then stores checked form information in a corresponding server. The configuration according to the second embodiment makes it possible to easily distinguish between a saving method for saving the entire form data and a saving method for save only input data removed from form information in a database.

According to the second embodiment, it is possible to check uploaded form information and input data according to required check level without a change to an application. In addition, a requesting client can know check result as soon as form information and input data are uploaded.

The present invention can be utilized widely in general systems utilizing offline form input functions. The present invention can be used as a travel expense adjustment system and a daily-report system for sales representatives, for, example. In addition, the present invention can be utilized for input applications in a large system such as the EAI.

1. A method of checking input form in a computer system including a server computer for checking form data and a client computer for inputting said form data, said method comprising:
allowing said server computer to create as-saved form information containing form information by form type requested and check information for verifying at least input data and to download said as-saved form information to the client computer of a requesting client;
allowing said client computer to receive said as-saved form information and upload to said server computer form data containing said as-saved form information and input data inputted offline to be added thereto; and
allowing said server computer to receive said form data, check said form information as required, and use said check information to verify said input data.

2. The method according to claim 1, wherein said check information contains input data check information for verifying said input data, user authentication information for authenticating a user of said client computer, and a check pattern indicating a level of check required for relevant form data.

3. The method according to claim 2, wherein said check pattern shows a combination of two or all of user authentication based on said user authentication information, form check based on said form information, and input data verification based on said input data check information.

4. The method according to claim 2, wherein said input data check information is a list of data item values stored in a master database and said input data is a data item value selected from said list.

5. The method according to claim 1, wherein said server computer further determines which of said entire form data checked or said input data contained in said form data to store in a database.

6. A program for performing a form check method using a computer, said program;comprising the steps of:
creating as-saved form information containing form information by form requested and check information for verifying at least input data and downloading said as-saved form information to a requesting client;
receiving form data containing said as-saved form information and input data inputted off line to be added thereto from said requesting client;
checking said form information; and
using said check information to verify said input data.

7. The program according to claim 6, wherein said check information contains input data check information for verifying said input data, user authentication information for authenticating a user of said client computer, and a check pattern indicating a level of check required for relevant form data.

8. The program according to claim 6, wherein said check pattern shows a combination of two or all of user authentication based on said user authentication information, form check based on said form information, and input data verification based on said input data check information.

9. The program according to claim 6, wherein the step of verifying said input data further comprises the steps of:
performing a user authentication based on user authentication information contained in said received form data;
checking said form based on said form data; and
verifying input data inputted into said form data.

10. A form check system for checking form data containing input data, said system comprising:
a server including:
a form transmitting unit for creating as-saved form information containing form information by form type requested and check information for verifying at least input data and downloading said as-saved form information to a requesting client; and
a form receiving unit for receiving form data containing said as-saved form information and input data inputted offline to be added thereto, checking said form information as required, and using said check information to verify said input data; and
a client including:
a form downloading unit for receiving said as-saved form information; and
a form uploading unit for uploading to said server said form data and said input data added thereto.

11. The form check system according to claim 10, wherein said check information contains input data check information for verifying said input data, user authentication information for authenticating a user of said client, and a check pattern indicating a level of check required for relevant form data.

12. The form check system according to claim 10, wherein said check pattern shows a combination of two or all of user authentication based on said user authentication information, form check based on said form information, and input data verification based on said input data check information.

13. The form check system according to claim 10, wherein said server further includes a form management database storing said form information, form master database retrieval conditions by said requested form, configuration information concerning said master database and said check pattern.

14. The form check system according to claim 10, wherein said client computer comprises a saved-form database for dividing said as-saved form information received by said form downloading unit into form information containing input item information and list items and check information containing input data check information, user authentication information, and check site information, for storing purposes.

15. The form check system according to claim 14, wherein said input item information is contained in the form information contained in the as-saved form information transmitted from said server and wherein said input data check information is contained in the check information contained in the as-saved form information transmitted from said server.

16. The form check system according to claim 10, wherein said form receiving unit further comprises:
a user authentication unit for performing user authentication based on user authentication information contained in the form data transmitted from said form uploading unit;
a form check unit for checking said form based on said form data; and
an input data check unit for verifying the input data inputted in said client computer that has transmitted said form data.

17. The form check system according to claim 14, wherein said form uploading unit further comprises:
a check site connecting unit adapted to connect with a check site for checking said form data, based on the check site information contained in said saved-form database; and
a check result notification unit for displaying a check result in said check site to said client computer.

18. The form check system according to claim 10, wherein said form receiving unit comprises a form storing unit for determining where to store the form data based on information showing where to store the form data.

19. The form check system according to claim 13, wherein said form management database stores a by-form storage pattern by which information showing where to store the form data is associated with a form name for storing purposes and wherein said form receiving unit comprises a form storing unit for determining where to store the form data based on said by-form storage pattern.

20. The form check system according to claim 19, wherein said by-form storage pattern contains information showing which of the form database contained in a database server connected to said server and a checked-form information database contained in a form server connected to said server to store said form data therein.
